(19) United States
(12) Patent Application Publication
(10) Pub. No.: US 2015/0097957 A1
(43) Pub. Date: Apr. 9, 2015

(54) TRAFFIC SURVEILLANCE SYSTEM

(71) Applicant: Kapsch TrafficCom AB, Jonkoping (SE)

(72) Inventor: Björn Crona, Jonkoping (SE)

(21) Appl. No.: 14/507,654

(22) Filed: Oct. 6, 2014

(30) Foreign Application Priority Data
Oct. 7, 2013 (EP) 13187587.4

(51) Int. Cl. G08G 1/017; G06K 9/00; H04N 7/18

(52) U.S. Cl. CPC G08G 1/0175; G08G 1/017; H04N 7/181; G06K 9/00771
USPC 348/149

(57) ABSTRACT

A traffic surveillance system adapted to track and register vehicles passing a surveillance zone is described herein. The system comprises a carrying structure and a traffic surveillance device that is adapted to be mounted upon the carrying structure and comprises at least a vehicle identity registration device and a vehicle tracking device. The surveillance zone comprises gateway zones and at least one interconnecting zone. The interconnecting zone connects at least two gateway zones with each other. The vehicle identity registration device is arranged such upon the carrying structure that it defines the gateway zones in that it is adapted to record a passage of a vehicle into or out from the surveillance zone through the gateway zones and the vehicle tracking device is arranged such upon the carrying structure that it defines an essentially arc shaped interconnecting zone.

### CROSS-REFERENCE TO RELATED APPLICATION(S)

This application claims priority to European Patent Application No. 13 187 587.4, filed on Oct. 7, 2013, the entirety of which is incorporated by reference herein.

### BACKGROUND

1. Technical Field

The present subject matter relates to a traffic surveillance system.

2. Background Art

Traffic surveillance systems are used to detect, monitor/track and register vehicles passing in a surveillance zone. The most commonly used traffic surveillance system comprises a gantry positioned across the road to be monitored with several devices arranged onto the gantry such that vehicles passing of the surveillance zone as well as the entry into and exit out of the surveillance zone may be monitored.

Requirements on a traffic surveillance system include tracking vehicles throughout the entire surveillance zone with a video camera or several cameras. The traffic surveillance system is often used in combination with road tolling. Cameras capturing the front and back licence plates of vehicles to be identified (so called ANPR (automatic number plate recognition) cameras), or transceivers communicating with transponders arranged in vehicles, are also often included in the traffic surveillance system. Lighting means (visible or invisible to human eye) providing light to the surveillance zone and the vehicles to be captured is also commonly included. The devices mentioned, and other devices provided in the traffic surveillance system, are all arranged upon the gantry and are in doing so also arranged at essentially the same height above the road, thereby restricting the range of possible working angles towards the surveillance zone. The height of the gantry across the road is such that all kinds of vehicles are able to pass under the gantry. The working angles of the devices enforced by the gantry are hence not always the most favourable for the various devices and applications of the traffic surveillance system.

Gantries may be large and obstructive in order to accommodate the devices needed to perform the surveillance and registration as well as to allow maintenance to be performed by climbing the gantry. The visual impact of a large gantry is often perceived as negative by by-passers or nearby residences.

An alternative to large gantries is to provide smaller gantries of less visual impact, but in order to install or perform maintenance on the devices arranged upon such gantries equipment such as lifting cranes are required to reach the devices situated high up across the road, and the road needs to be temporarily closed off to vehicle traffic passing under the gantry such that safe and efficient maintenance can take place. Hence, such traffic surveillance systems are quite burdensome to maintain.

If several roads are monitored and/or tolled several gantries with devices arranged upon them are needed; often one gantry per road in order to ensure accurate surveillance. Consequently the visual impact and implementation cost is large.

### BRIEF SUMMARY

There is hence a need for an improved traffic surveillance system removing the above mentioned disadvantages.

The object of the disclosed subject matter is to provide an improved traffic surveillance system adapted to track and register vehicles passing a surveillance zone in a reliable manner while still allowing installation and/or maintenance to be made in a manner that is simple and safe; the traffic surveillance system having low or no impact on the traffic flow and low visual impact. The object is achieved by system set out in the independent claim.

The traffic surveillance system of the disclosed subject matter is adapted to track and register vehicles passing a surveillance zone, the traffic surveillance system comprises a carrying structure and a plurality of traffic surveillance devices, wherein the traffic surveillance devices are adapted to be mounted upon the carrying structure and comprises at least a vehicle identity registration device and a vehicle tracking device, the surveillance zone being defined as the coverage of said traffic surveillance devices in a plane from which the carrying structure protrudes, wherein the surveillance zone comprises a plurality of gateway zones and at least one interconnecting zone that connects at least two gateway zones with each other.

In the example traffic surveillance system the vehicle identity registration device is arranged such upon the carrying structure, that it is adapted to record a passage of a vehicle into or out from the surveillance zone through the gateway zones, and thereby defines the gateway zones and the vehicle tracking device is arranged such upon the carrying structure that it defines an essentially arc shaped interconnecting zone.

The arc shape is defined as bend shape either continuously bend or discrete bend in steps. The bend of the arc shaped interconnecting zone can be arranged such that it is curved either about the carrying structure or away from it. The carrying structure can thereby be arranged adjacent to the surveillance zone instead of above as previously known.

The surveillance zone is defined as the as the area upon said surveillance plane, which the surveillance devices covers, i.e. capture area of the traffic surveillance devices. In an implementation of the surveillance system the surveillance area is adapted to correspond to the traffic area in which monitoring and/or registering of vehicles is desired. The gateway zones are part of the surveillance zone where the vehicles enter or exit the surveillance zone, i.e. are entrance/exit zones. The surveillance zone comprises at least two gateway zones such that a vehicle normally enters and exits the surveillance zone through different gateway zones. The gateway zones are connected by the interconnecting zone. By providing the interconnecting zone with an arc shape, it is provided for arranging the traffic surveillance system beside a curve of a road, for example, in the middle of a traffic round about.

The area of the interconnecting zone, defined by the vehicle tracking device, corresponds to the area of a road which the traffic surveillance system is intended to monitor when the system is installed. It is understood that in an implementation of the example system the surveillance plane is arranged parallel with a plane of a road that is to be monitored. The interconnecting zones overlap with each other or are at least arranged boundary to boundary to each other such that a vehicle passing several interconnecting zones, over the boundaries, may be continuously tracked by the vehicle tracking device.

The carrying structure may comprise one or several individual structures arranged to make up the carrying structure adapted to carry the traffic surveillance devices. One single structure may be used in order to reduce cost and visual impact. Due to the arc shaped interconnecting zones it is possible to place a surveillance system covering a plurality of roads, with just one surveillance system.

The vehicle identity registration device may comprise a plurality of vehicle identity registration cameras arranged to capture images of vehicles passing into or out of the surveillance zone through the gateway zones, the traffic surveillance system being provided with image processing means adapted to identify vehicles in images captured by said vehicle identity registration camera. Examples of a suitable vehicle identity registration device are an ANPR (automatic number plate recognition) camera or a camera recognising other distinct features of a vehicle, e.g. “fingerprinting”.

In one aspect, the vehicle identity registration camera is arranged below an average height of vehicles for which the traffic surveillance zone is adapted for. A small working angle is thereby achieved; the working angle being defined as the angle between the camera direction and the surveillance plane. A small working angle of the vehicle identity registration camera results in pictures captured essentially capturing only the front or rear of the vehicles. Such a vehicle identity registration camera position is beneficial because it facilitates a favourable identification of the registration number of the licence plate and minimizes the risk of unidentifiable licence plates in the captured pictures, due to lesser images processing.

The height at which the vehicle identity registration camera is arranged may however be higher or lower than the average height of vehicles for which the traffic surveillance zone is adapted for. One benefit of the traffic surveillance system is that the height, i.e. the vertical positioning upon the carrying structure, of the vehicle identity registration camera as well as the vehicle tracking device is not predetermined and may be adapted to the present use of the traffic surveillance system, thereby making the system flexible and versatile. The vehicle identity registration camera may be adjustably arranged upon the carrying structure such that the vertical position and thus also the working angle may be changed.

The vehicle identity registration cameras may be arranged such that they can capture images of a front or a rear of a vehicle entering or exiting said surveillance zone through said gateway zones with a camera direction essentially parallel with the surveillance plane. This corresponds to a working angle between the camera direction and the surveillance plane of zero degrees. If the vehicle identity registration camera is arranged parallel with the surveillance plane, a vehicle passing into or out from the surveillance zone through the gateway zones is captured by the camera essentially straight from ahead or essentially straight from the back, whereby the number plate and/or distinctive feature is clearly visible in the picture. Thereby, all vehicles entering or exiting the surveillance zone may be registered by identification of their licence plates or distinctive features. Other working angles may also be used. The working angle may be set depending on the type of traffic and the surveillance zone to be monitored. In some aspects, the identity registration camera(s) may be arranged to capture the vehicle passing into or out from the surveillance zone from an angle.

The vehicle tracking device may comprise at least one vehicle tracking camera, wherein the vehicle tracking camera is arranged at a position such that it can capture images of the surveillance zone from above and thereby define the arc shaped interconnecting zone. Capturing images of the surveillance zone from above essentially means that vehicles passing the surveillance zone are captured at an angle, wherein the angle is formed between the surveillance plane and the camera capturing direction. The vehicle tracking device may thus monitor a vehicle throughout the surveillance zone as it passes the interconnecting zones after entering via a gateway zone and exiting via the same or another gateway zone.

Part of the area captured by a vehicle tracking device may be masked such that the vehicle tracking device defines essentially arc shaped interconnecting zones; wherein the arc shaped interconnecting zones correspond to the area of a road to be monitored within the surveillance zone. The area of interest in the captured image may thus be reproduced in high resolution whereas unwanted noise in the image may be removed by masking. Identification and tracking of vehicles in the images are thus simplified.

The vehicle tracking camera may be a video camera, a camera taking pictures continuously or any other camera suitable for capturing an area of the surveillance zone and thereby defining the arc shaped interconnecting zones. The tracking camera can also be of a stereo camera type.

The traffic surveillance system may be provided with a plurality of vehicle tracking cameras. The vehicle tracking cameras are adapted to have a total capturing area comprising the whole surveillance zone. The plurality of vehicle tracking cameras may be positioned in different directions and their total capturing area include the gateway zones of the surveillance zone. The vehicle tracking cameras are arranged to define arc shaped interconnecting zones which are arranged boundary to boundary or overlapping each other. The images captured by the plurality of vehicle tracking cameras may be processed to provide a combined image of the entire surveillance zone.

The plurality of vehicle tracking cameras defines a plurality of interconnecting zones, which interconnecting zones together may form a circular area with an inner and outer boundary such that the carrying structure is provided inside the inner boundary; the circular area being arranged in the plane of the surveillance. The interconnecting zones together form part of a circular area, i.e. an arc or curve shaped area. Providing the carrying structure inside the inner boundary, which does not belong to the surveillance zone, allows access to the devices arranged upon the carrying structure from without disturbing the traffic flow of the monitored road. Hence, access for e.g. maintenance and upgrade of the traffic surveillance system may be performed without impacting the traffic flow.

The interconnecting zones may, for example, correspond to the area of the road to be monitored, wherein the road to be monitored is arc shaped. By providing the carrying structure inside the inner boundary of the round area the carrying structure is accessible from an area different from the interconnecting zones. Thereby, the devices arranged upon the carrying structure can be reached without obstructing the interconnecting zones, i.e. hindering traffic passing the surveillance zone.

In one aspect the surveillance zone is adapted to cover a traffic roundabout and the gateway zones are adapted to cover entrances of the traffic roundabout and the interconnecting zones are adapted to cover road areas of the entrances and the area in-between the entrances. The plane of the surveillance zone is arranged at the plane of the traffic roundabout, the carrying structure protruding from the plane of the surveillance zone. Normally, the traffic roundabout entrances (junctions) function as both entrances and exits of the roundabout, arranged to allow traffic to pass in both directions. The traffic surveillance devices are arranged to register as well as track vehicles in the gateway zones and in the interconnecting zones respectively independent of the direction of travel. Each vehicle entering the roundabout via an entrance can thereby be tracked throughout the roundabout by the vehicle tracking device and registered upon entry and exit by the vehicle identity registration device(s). The carrying structure may, for example, be provided inside the inner boundary of the area defined by the interconnecting zones; i.e. in the middle of the roundabout. By providing such a design several roads may be placed under surveillance by the same vehicle surveillance system. The need for several individual surveillance systems arranged at several individual roads are eliminated when monitoring the roads as they meet in the roundabout, and surveillance, especially tolling of all the roads entering the traffic roundabout may be performed by the single traffic surveillance system according to an aspect. Hence a traffic surveillance system according to an aspect is cost effective and has a high surveillance capacity. Because of the systems structure to be provided with a surveillance zone at least partially surrounding the mounting structure, the system can be arranged e.g. in a traffic roundabout in order to monitor a plurality of roads connecting to the traffic roundabout. The system may, for example, be adapted to be used as a tolling facility.

The traffic surveillance system may further be provided with lighting means in order to illuminate the surveillance zone. The lighting means is provided upon the structure distanced to the vehicle identity registration device and vehicle tracking device such that obstructions (for example, obstructions falling from the sky, such as rain and/or snow) are not illuminated immediately in front of the vehicle identity registration device and vehicle tracking device. Providing the lighting means and the cameras at different heights is possible because of the arrangement upon the carrying structure, the carrying structure protruding essentially perpendicular from the plane of the surveillance. The lighting means may be a directed street light, spotlight or other suitable light source, visible or invisible (to human eye) light source.

The lighting means may, for example, be provided such as to illuminate the surveillance zone from an angle and may, for example, be above the identify registration device. The vertical positioning upon the carrying structure, and hence the angle towards the surveillance zone, may, for example, be chosen such that by-passers, e.g. drivers, are not blinded by the light.

The lighting means is may, for example, be arranged upon the same structure as the vehicle identity registration device and vehicle tracking device or may also be provided at another individual structure than the individual structure upon which the vehicle identity registration device and vehicle tracking device are provided, the individual structures being part of the carrying structure.

The traffic surveillance system may further be provided with a radio transceiver for communication with a transponder adapted to be arranged within a vehicle. This is particularly useful when the traffic surveillance system is used for road tolling. A transceiver is adapted to communicate with the transponder and can thereby identify (register) and track a vehicle provided with the transponder. The transceiver can thereby act both as a registration and tracking device. A system can be provided with a transceiver as an additional registering and/or tracking device to the registration and tracking cameras or even be replacing them.

The vehicle tracking device and the vehicle identity registration device may be provided at significantly different heights upon the carrying structure, wherein each of the vehicle tracking device and the vehicle identity registration device are adapted to be provided at a respective height that optimizes a working angle towards their respective operation/capturing areas. When, for example, a vehicle registration camera is used, images from the front and rear of vehicles may be captured. Because the system allows the placement of the structure holding the traffic surveillance devices beside (or inside) the surveillance zone, the surveillance devices can be arranged at the height most suitable for them without affecting the traffic flow.

The height of the devices is defined as their vertical position upon the carrying structure in relation to the plane of the surveillance zone from which the carrying structure protrudes.

### BRIEF DESCRIPTION OF THE DRAWINGS/FIGURES

Further features and advantages of the disclosed subject matter will now be described in greater detail on the basis of exemplary embodiments with reference to the accompanying drawings. In the figures:

FIG. 1a shows a schematic drawing according to an embodiment.

FIG. 1b shows a schematic drawing according to another embodiment.

FIG. 2a shows a schematic view according to an embodiment.

FIG. 2b shows a schematic view according to another embodiment.

FIG. 3a shows a schematic view according to yet another embodiment.

FIG. 3b shows a schematic view according to a further embodiment.

### DETAILED DESCRIPTION

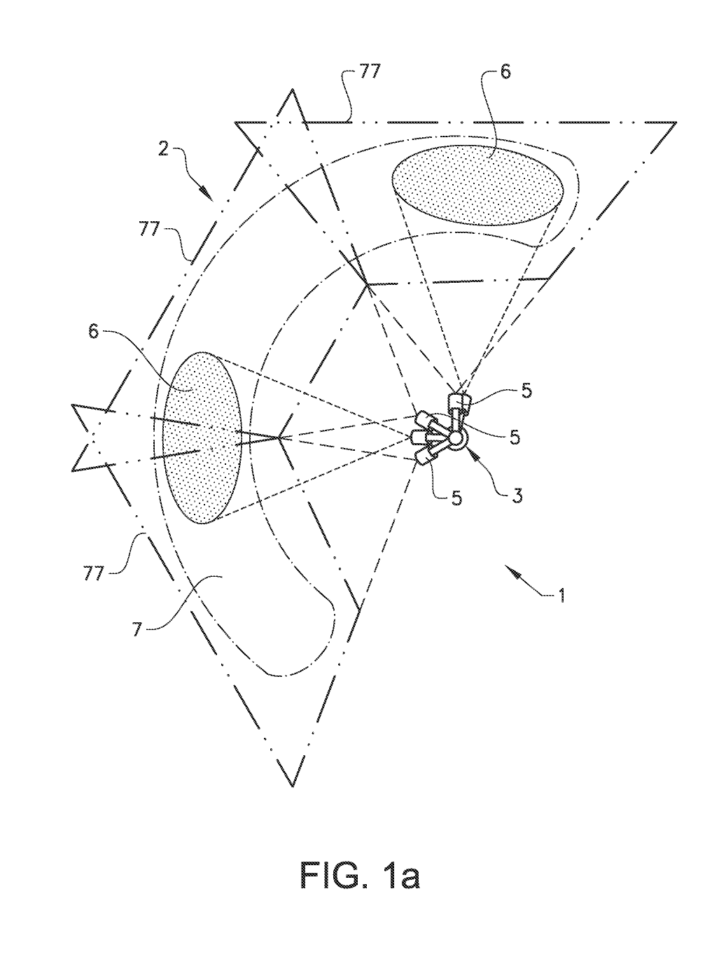

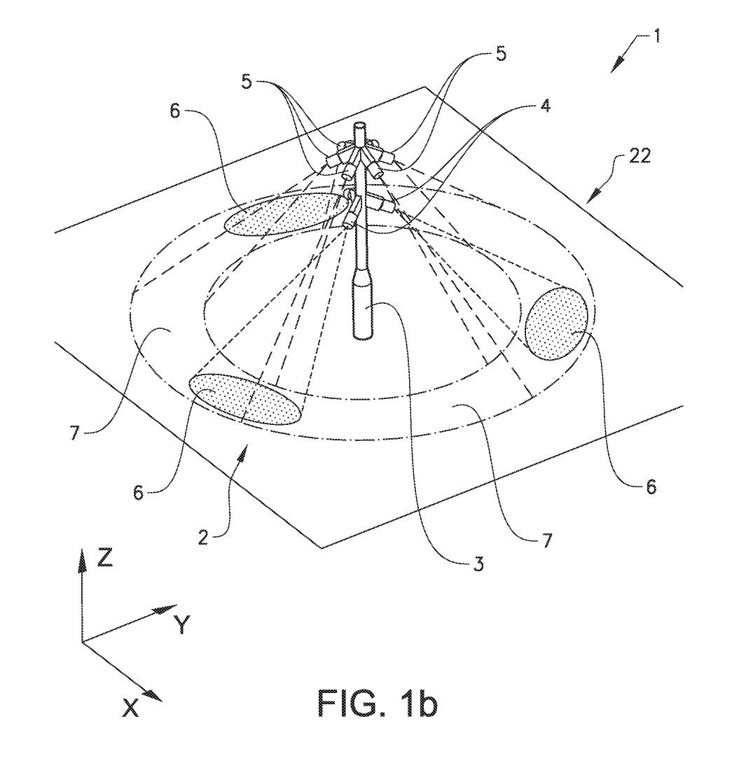

The traffic surveillance system 1 adapted to track and register vehicles passing through a surveillance zone 2 will now be described in conjunction with FIGS. 1a-3b. In the following, embodiments of the disclosed subject matter are described. The disclosed subject matter is however not limited thereto. All the figures are schematic.

In FIG. 1a the basic principle of the traffic surveillance system 1 is disclosed. In FIG. 1b an embodiment of the traffic surveillance system 1 is disclosed. The traffic surveillance system 1 comprises a carrying structure 3 upon which traffic surveillance devices 4, 5 are arranged. The traffic surveillance devices 4, 5 comprise at least a vehicle identity registration device 4 and a vehicle tracking device 5. The surveillance zone 2 is defined as an area covered by the traffic surveillance devices 4, 5 upon a plane 22; the coverage being the total area of the respective capturing area 6, 7 of each traffic surveillance device 4, 5 in the traffic surveillance system 1, see FIGS. 1a, 1b. The vehicle tracking devices 5 define essentially arc shaped interconnecting zone 7, which is built up by the capturing areas 77 of the vehicle tracking devices 5. The interconnecting zone 7 connects the gateways zones 6, which is defined by the capturing area of the vehicle identity registration device 4.

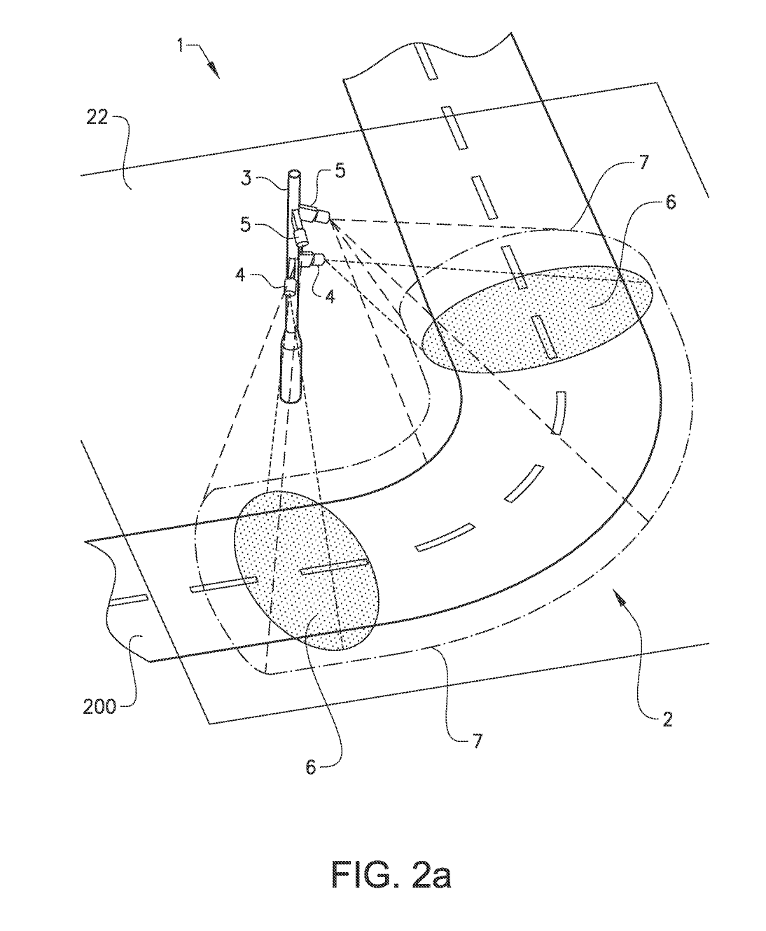

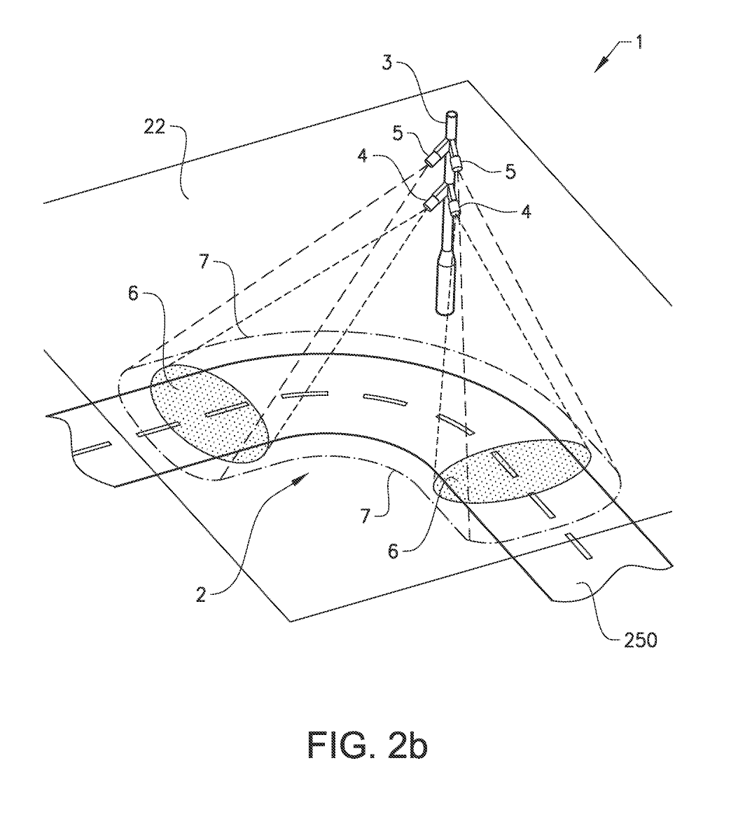

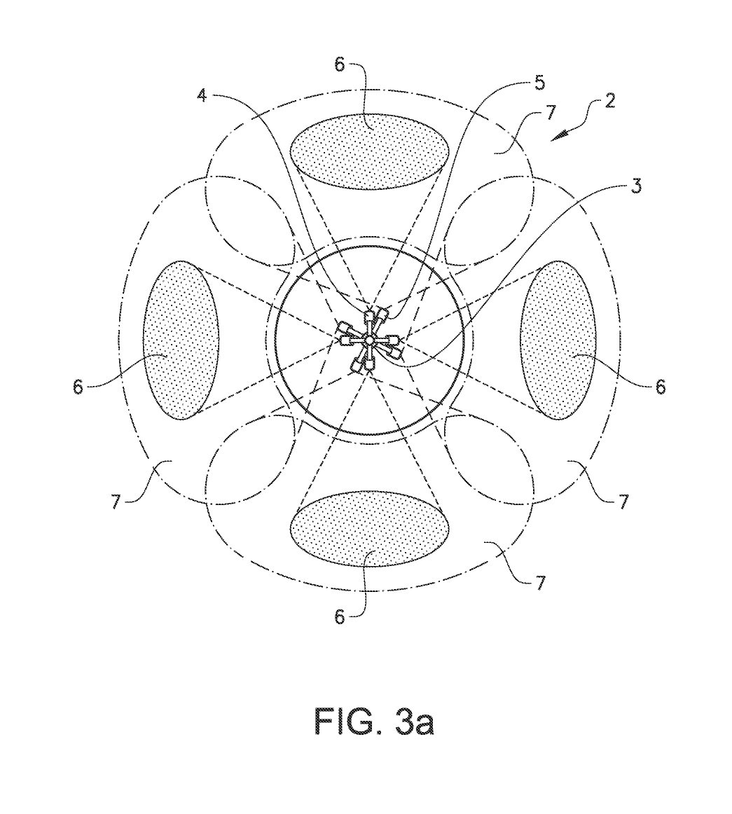

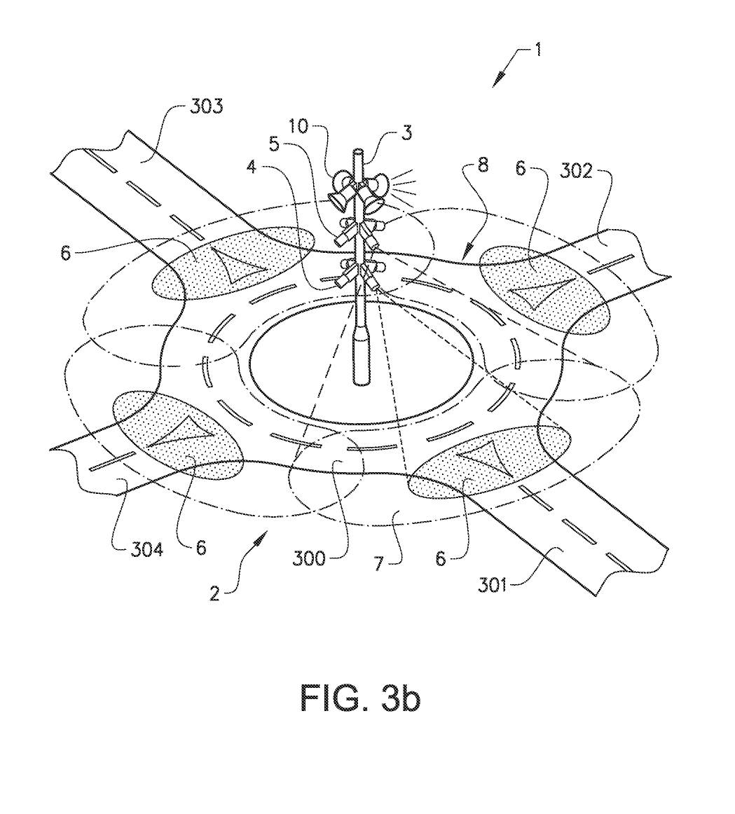

The surveillance zone 2 is provided in a plane 22 from which the carrying structure 3 protrudes, see FIG. 1b. Upon arranging the carrying structure 3 in a traffic zone, see FIGS. 2a-3b, the surveillance zone 2 is subsequently arranged in ground level corresponding to the plane of a road being put under surveillance by the traffic surveillance system 1. The interconnecting zone 7 is adapted to cover the road areas of the traffic zone. The carrying structure 3 extends in a mainly perpendicular direction of the plane 22 upon which the surveillance zone 2 is defined.

The vehicle registration devices 4 are arranged to define gateway zones 6; the gateway zones 6 being areas of the surveillance zone 2 at which vehicles pass when entering or exiting the surveillance zone 2. Thus, the number of gateway zones 6 to be defined depends on the traffic zone.

In FIG. 2a, the traffic surveillance devices 4, 5 comprise two vehicle identity registration devices 4 and a vehicle tracking device 5 arranged to register and track vehicles passing a curve of a road. The two vehicle identity registration devices 4, for example, registration cameras, are each arranged and directed to capture an area of the surveillance zone 2 at which a vehicle either enters or exits the surveillance zone 2; thereby defining two gateway zones 6. The registration cameras are arranged at suitable heights upon the carrying structure 3 such that they capture images of a front or a rear of a vehicle entering or exiting the surveillance zone 2 via the gateway zones 6.

The vehicle tracking device 5, is arranged upon the carrying structure 3 such that it captures the surveillance zone 2 of interest thereby also defining the arc shaped interconnecting zone 7, which encompasses the gateway zones 6. The vehicles thereby enters the surveillance zone 2 through one gateway zone 6 and exiting through the other gateway zone 6 and is tracked while passing through the whole surveillance zone 2.

Due to the configuration of the capturing area of the tracking devices 5, such that it defines an arc shaped interconnecting zone 7, the traffic surveillance system 1 can be beside a road 200 in a curve. The arrangement beside the road 200 gives several advantages, such as maintenance of the traffic surveillance system 1 can be done without interrupting the traffic upon the road 200.

The carrying structure 3 in FIG. 2a is positioned in the radial centre of a curve of a road 200. The carrying structure 3, a support of mainly vertical extension, allows the traffic surveillance devices 4, 5 to be arranged at various heights upon the carrying structure 3. The vehicle tracking device 5 is arranged above the vehicle identity registration devices 4 such that both devices can be arranged with their optimal working angle. A vehicle tracking device 5 provided as a camera is arranged at a height above the plane 22, such that it becomes a view from above in order to define the interconnecting zones 7. A vehicle identification device 4 provided as a vehicle identification camera 4 may, for example, be provided at a height such that it can capture images from the front and the rear of vehicles passing into/out of the gateway zones 6. This is allowed due to the arrangement beside the road 200.

The setup of the traffic surveillance system 1 is the same in FIG. 2b as in FIG. 2a, but the carrying structure 3 is positioned outside the curve of the road 250, thereby facing the outer perimeter of the arc shaped interconnecting zone 7.

In FIG. 3a another example of the traffic surveillance system 1 is disclosed. The traffic surveillance system 1 comprises a plurality of vehicle identity registration cameras 4, which are arranged such that gateway zones 6 are defined, whereby the gateway zones 6 being the capturing area of the vehicle identity registration cameras 4. The gateway zones 6 are comprised within the interconnecting zone 7 which is defined by the capturing area of the vehicle tracking cameras 5. The vehicle tracking cameras 5 capturing areas 77 (e.g., as shown in FIG. 1a) define the surveillance zone 2 and the interconnecting zone 7 such that it is defines an essentially circular interconnecting zone provided with an inner and outer boundary. The carrying structure 3 is positioned inside the inner boundary of the round area formed by the interconnecting zone 7. In FIG. 3a the surveillance zone 2 comprises four gateway zones 6 defined by four vehicle identity registration cameras 4 and one interconnecting zone defined by four vehicle tracking cameras 5. The capturing areas 77, defined by the vehicle tracking cameras 5, are achieved by the arrangement and direction of the tracking cameras 5 such that the interconnecting zone 7 and thereby the surveillance zone 2 becomes the desired circular shape. Hence, the vehicle tracking device 5 may have fewer or more tracking cameras than exemplified above, resulting in fewer or more capturing areas 77. The capturing areas 77 may be masked in order to not capture parts of the surrounding, which are outside the desired surveillance area.

The traffic surveillance system 1 disclosed above may be beneficially implemented for traffic surveillance in a traffic roundabout 8, as can be seen in FIG. 3b. One beneficial use of the system 1 is as a tolling system in a traffic roundabout 8. The carrying structure 3 is positioned in the centre of the roundabout 8, whereby the carrying structure 3 and the surveillance devices 4, 5 thereon are accessible for maintenance without disturbing the traffic flow through the roundabout 8. The vehicle identity registration devices 4, arranged upon the carrying structure 3, are positioned such that each of the vehicle identity registration devices 4, for example, registration cameras, captures one each of the roundabout junction areas, where the connecting roads 301, 302, 303, 304 connect with the road 300 of the traffic roundabout 8. The vehicle identity registration cameras 4 are arranged to be essentially parallel with the ground and at a height corresponding to an average height of vehicles for which the traffic roundabout 8 is adapted for; thereby optimized to capture the front or rear of a vehicle entering or exiting the roundabout 8 through a junction. License plates can thereby be registered e.g. by ANPR or fingerprint technology, further can an image of the vehicle driver be captured with the same camera. The advantageous arrangement of the vehicle identity registration cameras 4 at the same height as the vehicles simplifies an automatic reading of licence plates due to the lesser distortion of the image.

Tracking of the vehicles in between the connecting roads 301, 302, 303, 304 along the road 300 of the traffic roundabout 8 is performed by the vehicle tracking cameras 5. A plurality of vehicle tracking cameras 5 are arranged at a height and working angle such that the arc shaped interconnecting zone 7 is defined by the capturing areas 77 (for example, as shown in FIG. 1a) of the tracking cameras. The traffic surveillance system 1 is arranged such that the circular interconnecting zone 7 covers the entire road area 300 of the traffic roundabout 8. The traffic surveillance system 1 can thereby track a vehicle passing from one gateway zone 6 where it is registered by a vehicle registration camera 4, through the traffic roundabout 8, to a gateway zone 6 from which it leaves the traffic roundabout 8 and is registered by another vehicle registration camera 4. The vehicle tracking cameras 5 are arranged upon the carrying structure 3 such that the images captured of the surveillance zone 2 are taken at an angle, allowing the vehicles in the surveillance zone 2 to be captured from above.

The traffic surveillance system 1 in FIGS. 3a and 3b is provided with a lighting means 10. The lighting means 10 is arranged at a different height upon the carrying structure 3 than the vehicle identity registration devices 4 and directed towards the roundabout 8 in order to illuminate the surveillance zone 2.

When installing or maintaining a traffic surveillance system 1 as disclosed in the examples above the traffic passing the surveillance zone 2 does not need to be re-directed to the carrying structure 3. Because vehicles entering the traffic roundabout 8 enter directed towards the traffic surveillance system 1, the vehicle identification cameras can capture a clear image of fronts and rears of vehicles entering and exiting the traffic roundabout 8. When used for collecting toll charges, the arrangement of the traffic surveillance system 1 in a traffic roundabout 8 enables a toll charging of all the roads 301, 302, 303, 304 that enter the traffic roundabout 8 with only one traffic surveillance system 1.

### CONCLUSION

The invention is not limited to the specific embodiments presented, but includes all variations within the scope of the present claims.

For example the carrying structure 3 may comprise one or several individual structures upon which the traffic surveillance devices 4, 5 may be arranged at different heights.

Reference signs mentioned in the claims should not be seen as limiting the extent of the matter protected by the claims, and their sole function is to make claims easier to understand.

As will be realised, the invention is capable of modification in various obvious respects, all without departing from the scope of the appended claims. Accordingly, the drawings and the description thereto are to be regarded as illustrative in nature, and not restrictive.

What is claimed is:

1. A traffic surveillance system, wherein said system is adapted to track and register vehicles passing a surveillance zone, said traffic surveillance system comprising:
a carrying structure;
and a plurality of traffic surveillance devices, wherein said traffic surveillance devices are adapted to be mounted upon said carrying structure and comprises:
at least a vehicle identity registration device; and
a vehicle tracking device, said surveillance zone being defined as the coverage of said traffic surveillance devices and provided in a plane from which the carrying structure protrudes, wherein said surveillance zone comprises:
a plurality of gateway zones and at least one interconnecting zone that connects at least two gateway zones with each other, wherein said vehicle identity registration device is arranged such upon said carrying structure that it defines said gateway zones in that it is adapted to record a passage of a vehicle into or out from said surveillance zone through said gateway zones and said vehicle tracking device is arranged such upon said carrying structure that it defines an essentially arc shaped interconnecting zone.

2. The traffic surveillance system according to claim 1, wherein said vehicle identity registration device comprises a plurality of vehicle identity registration cameras arranged to capture images of vehicles passing into or out of said surveillance zone through said gateway zones, wherein said traffic surveillance system is provided with image processing means adapted to identify vehicles in images captured by said vehicle identity registration cameras.

3. The traffic surveillance system according to claim 2, wherein said vehicle identity registration cameras are arranged below an average height of vehicles for which said traffic surveillance zone is adapted for.

4. The traffic surveillance system according to claim 2, wherein said vehicle identity registration cameras are arranged such that they can capture images of a front or a rear of a vehicle entering or exiting said surveillance zone through said gateway zones with a camera direction essentially parallel with the ground.

5. The traffic surveillance system according to claim 1, wherein said vehicle tracking device comprises at least one vehicle tracking camera, wherein said vehicle tracking camera is arranged at a position such that it can capture images of said surveillance zone from above and thereby define said arc shaped interconnecting zone.

6. The traffic surveillance system according to claim 5, wherein said vehicle tracking device comprises a plurality of vehicle tracking cameras.

7. The traffic surveillance system according to claim 6, wherein said plurality of vehicle tracking cameras defines a plurality of interconnecting zones, which interconnecting zones together form a circular area with an inner and outer boundary such that said carrying structure is provided inside said inner boundary.

8. The traffic surveillance system according to claim 1, wherein said surveillance zone is adapted to cover a traffic roundabout and said gateway zones are adapted to cover entrances to said traffic roundabout and said at least one interconnecting zone are adapted to cover road areas of said entrances and in-between said entrances.

9. The traffic surveillance system according to claim 1, wherein said traffic surveillance system further is provided with lighting means in order to illuminate said surveillance zone, wherein said lighting means are provided distanced to said vehicle identity registration device and vehicle tracking device such that obstructions are not illuminated immediately in front of said vehicle identity registration device and vehicle tracking device.

10. The traffic surveillance system according to claim 1, wherein said traffic surveillance system further is provided with a radio transceiver for communication with a transponder adapted to be arranged within a vehicle.

11. The traffic surveillance system according to claim 1, wherein said vehicle tracking device and said vehicle identity registration device are provided at significantly different heights upon said carrying structure, wherein said vehicle tracking device and said vehicle identity registration device are adapted to be provided at a respective height that optimizes a working angle towards their respective operation/capturing areas.
